(19) United States
(12) Patent Application Publication
(10) Pub. No.: US 2014/0242403 A1
(43) Pub. Date: Aug. 28, 2014

(54) SELF-POLISHING ANTIFOULING PAINT COMPOSITION COMPRISING SOLID PARTICLES OF ENTRAPPED OR ENCAPSULATED ROSIN CONSTITUENTS

(71) Applicants: Stefan Møller Olsen, Kobenhavn O (DK); Diego Meseguer Yebra, Kobenhavn O (DK); Torben Schandel, Birkerod (DK)

(72) Inventors: Stefan Møller Olsen, Kobenhavn O (DK); Diego Meseguer Yebra, Kobenhavn O (DK); Torben Schandel, Birkerod (DK)

(73) Assignee: HEMPEL A/S, Kgs. Lyngby (DK)

(21) Appl. No.: 14/342,948

(22) PCT Filed: Sep. 6, 2012
(86) PCT No.: PCT/DK2012/050331

§ 371 Date: May 14, 2014

(30) Foreign Application Priority Data
Sep. 6, 2011 (EP) 11180197.3

(51) Int. Cl. C09D 5/16

(52) U.S. Cl. CPC C09D 5/1687
USPC 428/497; 524/272; 524/271; 523/210

(57) ABSTRACT

The present application discloses novel self-polishing antifouling paint compositions comprising: 30-80% by solids volume of the paint composition of a binder phase; 20-70% by solids volume of the paint composition of a pigment phase, said pigment phase including solid particles consisting of one or more rosin constituents (e.g. rosin, rosin derivatives or rosin-modified polymers) entrapped or encapsulated in a matrix (e.g. a silica such as a silica aerogel); and optionally one or more solvents. The application further discloses a) a method for the preparation of the self-polishing antifouling paint composition, comprising bringing solid particles consisting of one or more rosin constituents entrapped or encapsulated in a matrix in admixture with a binder system and one or more constituents selected from dyes, additives, solvents, pigments, fillers, fibres and anti-fouling agents, and any other suitable constituents to be included in either the binder phase or the pigment phase of paint compositions; b) a method for providing a self-polishing effect of a paint composition, the method comprising the step of incorporating into the paint composition the solid particles; and c) a marine structure.

### FIELD OF THE INVENTION

The present invention relates to self-polishing antifouling paint composition comprising solid particles of entrapped or encapsulated rosin constituents. Solid particles of this nature render it possible to substitute a portion of seawater-soluble pigments such as Cu₂O and ZnO.

### BACKGROUND OF THE INVENTION

As explained in Yebra et al. (Yebra, D. M., Kiil, S., Weinell, C., Dam-Johansen, K.; “Dissolution Rate Measurements of Sea Water Soluble Pigments for Antifouling Paints: ZnO”, Progress in Organic Coatings 56(4) (2006), 327-337)), a significant decrease in the Cu₂O load of existing antifouling paint technologies will require the use of an alternative seawater-soluble pigment. Except for Cu₂O and ZnO, common pigments and fillers currently used in paint technology are seawater-insoluble. When Cu₂O and/or ZnO are replaced by such pigments or fillers the paint exhibits a reduced polishing rate (i.e. the rate at which the film thickness of the antifouling coating decreases). After immersion in seawater, a porous leached layer will develops at the outermost layer of the coating due to dissolution of the seawater soluble pigment constituents in contact with seawater. The surface area of the pore walls of the leached layer determines the extent of the degradation/dissolution of the binder. When the binder at the paint surface has been degraded/dissolved to a given extent (after the so-called “lag-time”), the surface becomes weak enough to be dissolved/eroded by the action of moving seawater.

Hence, when seawater soluble pigments such as Cu₂O and/or ZnO are replaced by less soluble particles, the leached layer's pore wall surface area is diminished, and so is the rate of degradation/dissolution of the binder. This typically leads to a lower polishing rate and increased leached layer thickness. Additionally, thicker leach layers lead to increased diffusion resistance of the active ingredients in the coating, leading to lower flux at the seawater-coating interphase and, ultimately, to reduced antifouling performance.

As pointed out in Kiil et al. (Kiil S., Dam-Johansen K., Weinell C. E., Pedersen M. S.; “Seawater-soluble pigments and their potential use in self-polishing antifouling paints: simulation-based screening tool”, Progress in Organic Coatings 45(4), 423-434), the required properties that a suitable soluble pigment must fulfil are not common amongst inorganic materials except for environmentally-harmful heavy-metal containing products such as lead or mercury derivatives. This is unfortunate, since inorganic materials would be the most attractive alternatives due to their generally lower price. Antifouling literature demonstrates that only few existing organic materials have a solubility in seawater adequate for their use in antifouling paint compositions. However, those few candidates, such as e.g. rosin derivatives, are typically readily dissolved by the solvent of the paint composition, hence it will become part of the binder phase of the paint composition.

To date, seawater-soluble binder components cannot be used to replace Cu₂O and/or ZnO in a significant degree because it would increase the hydrophilicity of the paint too much, leading to high water absorption and subsequent early dissolution of biocides, and other soluble material throughout the film. It is important in antifouling paints that only the outermost layers of the paint react with seawater while the rest of the paint remains largely unreacted. A second reason, explained above, is the need for a certain degree of solid soluble material so as to give rise to a porous layer with enough surface area to degrade/dissolve the relatively slow degrading/dissolving (not too hydrophilic) binder components. Also, lowering the Pigment Volume Concentration (PVC) will compromise the physical properties of the dry paint film. Finally, increasing the amount of binder components will require a higher amount of solvent to dissolve the binder components.

In view of the problems outlined above there is a need for a formulation concept that enables the use of binder components as soluble fillers. Such a concept will make it possible to increase the amount of seawater-soluble binder components without the need for increasing the amount of solvent, and without losing control of the polishing properties and without reducing the Pigment Volume Concentration (PVC).

### SUMMARY OF THE INVENTION

In view of the above-mentioned objective, the present invention provides novel self-polishing antifouling paint composition based on a new principle in that the present inventors have found that the need for seawater-soluble pigments such as Cu₂O and ZnO can be dramatically reduced or even eliminated by incorporation of certain solid particles.

Moreover, the results so far have indicated that the initiation of the polishing takes place without any significant increase in lag-time.

The invention provides novel self-polishing antifouling paint compositions comprising: 30-80% by solids volume of the paint composition of a binder phase; 20-70% by solids volume of the paint composition of a pigment phase, said pigment phase including solid particles consisting of one or more rosin constituents entrapped or encapsulated in a matrix; and optionally one or more solvents.

The invention further provides a method for the preparation of the self-polishing antifouling paint composition as defined herein, said method comprising the step of bringing solid particles consisting of one or more rosin constituents entrapped or encapsulated in a matrix in admixture with a binder system and one or more constituents selected from dyes, additives, solvents, pigments, fillers, fibres and anti-fouling agents, and any other suitable constituents to be included in either the binder phase or the pigment phase of paint compositions.

The invention still further provides a method for providing a self-polishing effect of a paint composition, the method comprising the step of incorporating into the paint composition solid particles consisting of one or more rosin constituents entrapped or encapsulated in a matrix.

### BRIEF DESCRIPTION OF THE FIGURES

FIG. 1 shows the mechanisms involved in polishing of an antifouling coating, dividing the process into three steps. 1: An antifouling coating consisting of a binder phase including a binder system and a discontinuous phase including pigments and/or fillers as well as the solid particles defined herein. A freshly immersed antifouling coating will leach seawater-soluble pigments and the rosin constituents of the solid particles into the sea. 2: Seawater-filled pores left behind by the eluted seawater-soluble pigments and rosin constitute the leached layer of the coating. The surface area of the water/coating interface is increased by formation of the leached layer, which allows for more interactions between water and the residues of the binder phase. 3: As a result the outermost layer of the coating is released into seawater.

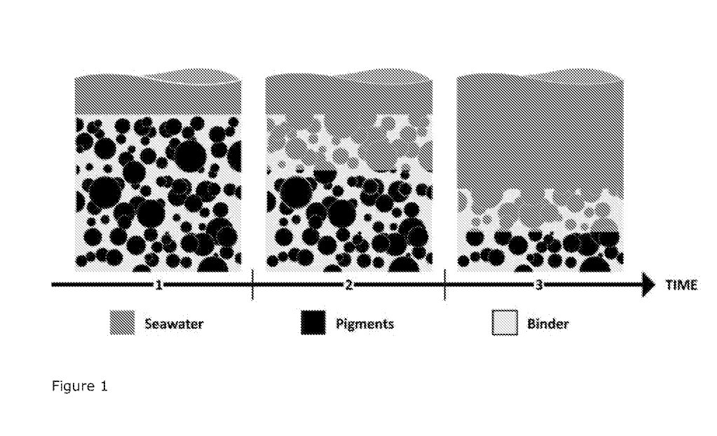

### DETAILED DESCRIPTION OF THE INVENTION

The present invention is based on the concept of including in a self-polishing antifouling paint composition one or more rosin constituents which are entrapped or encapsulated in or within a matrix. Hence, in contrast to conventional paint compositions, the rosin constituent (in the entrapped or encapsulated form) replaces (or even eliminates) a part of the pigment/filler phase of the paint composition instead of forming part of the binder phase. By means of the entrapped or encapsulated rosin constituents, it is rendered possible to reduce or even eliminate the presence of Cu₂O and/or ZnO in the paint composition while still preserving the self-polishing properties of the paint composition.

When preparing the paint composition, the one or more rosin constituents will essentially remain entrapped or encapsulated in the material. However, upon exposure to seawater, the rosin constituent will gradually be dissolved (possibly after hydrolysis) in the seawater which will ultimately contribute to the self-polishing properties of the paint composition.

As mentioned above, the present invention provides novel self-polishing antifouling paint compositions comprising:

30-80% by solids volume of the paint composition of a binder phase;
20-70% by solids volume of the paint composition of a pigment phase, said pigment phase including solid particles consisting of one or more rosin constituents entrapped or encapsulated in a matrix; and
optionally one or more solvents.

The solid particles typically have an (weight) average diameter of 0.10-50 μm.

The paint composition

The paint composition (occasionally referred to as “a paint” or “a coating composition”) typically consists of a binder phase (which forms the paint film upon drying and thereby corresponds to the continuous phase of the final paint coat) and a pigments phase (corresponding to the discontinuous phase of the final paint coat).

In the present context, the binder phase is in the form of a binder system. Binder systems to be utilized in the present context are conventional systems as will be appreciated by the skilled person. Examples of currently preferred binder systems to be utilised within the concept of the present invention are described further below.

The paint composition also comprises, as a part of the pigment phase solid particles as further defined herein.

In most practical embodiments, the binder phase constitutes 30-80% by solids volume of the paint composition and the pigment phase constitutes 20-70% by solids volume of the paint composition. In preferred embodiments, the binder phase constitutes 50-70% by solids volume, such as 55-65% by solids volume of the paint composition and the pigment phase constitutes 30-65% by solids volume, such as 35-55% by solids volume of the paint composition.

When expressed by wet weight, typically the binder phase constitutes 15-70% by wet weight of the paint composition and the pigment phase constitutes 20-80% by wet weight of the paint composition. In preferred embodiments, the binder phase constitutes 20-60% by wet weight of the paint composition and the pigment phase constitutes 25-75% by wet weight of the paint composition.

In most embodiments, the binder phase constitutes 15-70% by wet weight of the paint composition and the pigment phase constitutes 30-85% by wet weight of the paint composition. In other embodiments the invention disclosed is copper free or copper-less. In these embodiments, the binder phase constitutes 30-85% by wet weight of the paint composition and the pigment phase constitutes 15-40% by wet weight of the paint composition.

Without being limited to one particular theory, it is however believed that the solid particles consisting of one or more rosin constituents entrapped or encapsulated in a matrix (in addition to the effect of any binder phase constituents, pigments, fillers, antifouling agents, etc.) provide a unique possibility for providing a sufficient, even (i.a. with a limited lag-time before initiation of the polishing) and long-term self-polishing rate.

When used herein, the term “self-polishing” is intended to mean that the paint coat (i.e. the dried/cured film of the paint composition) should have a polishing rate of at least 1 μm per 10,000 Nautical miles (18,520 km), determined in accordance with the “Polishing rate test” specified in the Examples section. Preferably the polishing rate is in the range of 1-50 μm, in particular in the range of 1-30 μm, per 10,000 Nautical miles (18,520 km).

### The Pigment Phase

A main feature of the paint composition of the present invention is the inclusion of solid particles consisting of one or more rosin constituents entrapped or encapsulated in a matrix. Such solid particles constitute a part of the pigment phase of the paint composition.

The solid particles are meant to substitute at least a portion of seawater-soluble pigments (e.g. Cu₂O and ZnO) frequently used in conventional self-polishing antifouling paint composition. The solid particles should therefore have a suitable size in order to effectively simulate the presence of such seawater-soluble pigments.

Typically, the weight average diameter of the solid particles is 0.10-50 μm, such as 0.30-40 μm, or 0.50-30 μm, or 0.80-20 μm, or even 1-15 μm. The weight average diameter of the solid particles may be determined as described in the Examples section.

In the present context, the expression “solid particles” is intended to mean that the particles are in solid form (i.e. non-confluent) at a temperature of 25° C., 1 atm., at a relative humidity of 60% for 72 hours. Furthermore, solids particles according to the present invention are characterised by appearing in the paint composition in the same manner as conventional pigments and fillers. The solid particle defined herein will therefore appear in the final coating in the same form as the form in which they are added to the paint composition.

The solid particles are further characterized by consisting of one or more rosin constituents entrapped or encapsulated in a matrix.

The one or more rosin constituents are typically selected from rosin (as such), rosin derivatives as well as rosin-modified polymers.

In the present context, the term “rosin” is intended to mean gum rosin; wood rosin of grades B, C, D, E, F, FF, G, H, I, J, K, L, M, N, W-G, W-W (as defined by the ASTM D509 standard); virgin rosin; hard rosin; yellow dip rosin; NF wood rosin; tall oil rosin; or colophony or colophonium; as well as any of the single constituents of natural rosin qualities, e.g., abietic acid, abietinic acid, sylvic acid, dihydroabietic acid, tetrahydroabietic acid, dehydroabietic acid, neoabietic acid, pimaric acid, laevopimaric acid, isopimaric acid, sandaracopimaric acid, palustric acid, dextro-pimaric acid, isodextro-pimaric acid, cativinic acid, eperuanic acid and all other rosin components based on the diterpene skeleton of abietic acid; as well as any mixtures thereof. It is understood that the term “rosin” may indicate any mixtures of the chemical species mentioned above as well as any of the chemical species as such.

In the present context the term “rosin derivative” is intended to mean all types of rosin (as defined above) modified or derivatised according to any of the following chemical reactions or processes: polymerisation/oligomerisation; esterification; metal salt formation/formation of metallic resinates; ammonium salt formation; hydrogenation; dehydrogenation-hydrogenation/disproportionation/dismutation; as well as mixtures thereof.

Rosin-modified polymers are preferably those based on a polymer backbone having carboxylic acid side-chains like poly acrylates, polymethacrylates and poly(acrylate-co-methacrylate)s. Such polymers are modified with rosin or rosin derivatives via hydrolysable chemical bonds, in particular ester bonds. An illustrative example is provided in the Examples section. In addition, to polymers having carboxylic acid side-chains, rosin may be modified onto polymers having hydroxyl-functional side groups.

Preferably, rosin or rosin derivatives constitute at least 50% by weight of the rosin-modified polymer.

In one interesting embodiment, the one or more rosin constituents include rosin-modified polymers. In such instances, the weight average molecular weight of the rosin-modified polymer is typically at least 1,500 g/mol, such as 1,500-200,000 g/mol, e.g. 3,000-100,000 g/mol.

Suitable matrices for entrapping or encapsulating the one or more rosin constituents are silica gels (e.g. silica aerogels, silica xerogels, silica cryogels or aeromosils), gels of carbon (e.g. carbon aerogels, carbon cryogels, carbon xerogels), gels of alimina (e.g. alumina aerogels, alumnia cryogels, alumina xerogels), and polymer materials such as those based on polylactides (PLA), polyglycolides (PGA), poly(lactide-co-glycolides) (PLGA), polyanhydrides, polyorthoesters, poly(2-hydroxy ethyl methacrylate), poly(n-vinyl pyrrolidone), poly(vinyl pyrrolidone), poly(methyl methacrylate), poly(vinyl alcohol), poly(acrylic acid), polyacrylamide, poly(ethylene-co-vinyl acetate), poly(ethylene glycol), poly(methacrylic acid), poly(urethanes), poly(siloxanes), poly(methyl methacrylate), poly(vinyl alcohol), and poly(ethylene), polyurethane, polyurea, hydrolyzed poly(vinyl alcohol), phenolic resin (e.g. poly(vinyl alcohol)-urea-resorcinol-glutaralde, poly(vinyl alcohol)-urea-resorcinol-formaldehyde), polyisocyanate (aromatic and aliphatic), amino-formaldehyde (e.g. melamine-formaldehyde), gelatin-gum arabic.

The stability of the matrix towards solvent should be limited to organic solvent. In seawater, the matrix should be either degradable, erodible or allow for water penetration. The matrix may be degraded chemically as it happens with hydrolysis in water. Alternatively, the matrix may be eroded away by purely mechanical effects as it is occurring when solid particles are present at a surface where friction wear down the particles, or the matrix may erode away due to a collapse of the matrix after dissolution/degradation of some or all of the entrapped rosin constituents.

It is beneficial that the solid particles have low or even no solubility in conventional solvent systems used for industrial paint compositions.

In one embodiment, the solid particles are mainly insoluble in xylene, typically such that at least 60% of the weight of a sample of the solid particles is maintained after testing in the Xylene Stability Test described in the Examples section. Preferably at least 70% of the weight of a sample, such as 80% of the weight of a sample, in particular at least 85% by weight of a sample, e.g. at least 90% by weight of a sample, or at least 95% by weight of a sample, is maintained after testing in the Xylene stability Test described herein.

In a further embodiment, the one or more rosin constituents are entrapped in the pores of the matrix, such as a silica gel, in particular an aerogel.

In a still further embodiment, the particles consist of rosin, a rosin derivative and/or a rosin-modified polymer entrapped in the pores of a silica gel, in particular an aerogel.

In one important embodiment, the matrix is a silica gel. In one embodiment, the matrix is an aerogel, e.g. an aerogel of silica. In one variant, the material is an aerogel, e.g. an aerogel of silica where the degradation is controlled by incorporation of metal alkoxides, optionally alkoxides wherein one or two alkoxy groups have been replaced by alkyl (e.g. C1-6 alkyl) or aryl (e.g. phenyl).

In a still further embodiment, the one or more rosin constituents are encapsulated within a shell of the matrix material.

In a still further embodiment, the shell of the matrix within which the one or more rosin constituents are encapsulated is water-permeable.

In one embodiment, the degradation of the encapsulating material happens with hydrolysis in seawater. In such a case it is envisaged that the encapsulation material itself or “empty” capsules may be suited as soluble fillers. In both cases, the soluble filler must not increase the water absorption of the paint to a large extent and should allow replacing Cu₂O/ZnO in PVC without large changes in the PVC/CPVC ratio (CPVC=critical pigment volume concentration).

The solid particles describe hereinabove are typically present in a total amount of 1-50% by solids volume, such as 1-30% by solids volume, of the paint composition, e.g. 1-15% by solids volume, or 10-30% by solids volume.

In some embodiments, the solid particles are present in an amount of 1-90% by solids volume, such as 1-60% by solids volume, of the pigment phase, e.g. 1-30% by solids volume, or 20-50% by solids volume.

When expressed by wet weight, the solid particles are typically present in an amount of 1-30% by wet weight, such as 1-20% by wet weight, of the paint composition, e.g. 1-15% by wet weight, or 10-30% by wet weight.

In some embodiments (when expressed by wet weight), the solid particles are present in an amount of 1-80% by wet weight, such as 1-50% by wet weight, of the pigment phase, e.g. 1-25% by wet weight, or 15-40% by wet weight.

### Other Constituents of the Pigment Phase

The pigment phase (i.e. the phase corresponding to the discontinuous phase of the final (dry) paint coat) may in addition to the solid particles described above also include pigments, filler, fibres and antifouling agents.

Such other constituents of the pigment phase (i.e. constituents besides the solid particles defined above) are not strictly mandatory components. However, such other constituents are typically incorporated in a total amount of up to 60%, such as up to 50% by solids volume, e.g. in amounts of 20-50% or 35-50% by solids volume of the paint composition. When related to the wet weight of the total composition, such other constituents are typically incorporated in a total amount of up to 60%, such as up to 50% by wet weight, e.g. in amounts of 0.1-40%, or 0.1-30%, by wet weight of the paint composition.

Examples of pigments are grades of metal oxides such as cuprous oxide (Cu₂O) and cupric oxide (CuO) (even though e.g. cuprous oxide and cupric oxide may have antifouling agent characteristics, it is understood that in the present context such metal oxides are only considered as “pigments”), titanium dioxide, red iron oxide, zinc oxide, carbon black, graphite, yellow iron oxide, red molybdate, yellow molybdate, zinc sulfide, antimony oxide, sodium aluminium sulfosilicates, quinacridones, phthalocyanine blue, phthalocyanine green, titaniumdioxide, black iron oxide, graphite, indanthrone blue, cobalt aluminium oxide, carbazole dioxazine, chromium oxide, isoindoline orange, bis-acetoacet-o-tolidiole, benz-imidazolon, quinaphtalone yellow, isoindoline yellow, tetrachloroisoindolinone, quinophthalone yellow. Such materials are characterised in that they render the final paint coat non-transparent and non-translucent.

When cuprous oxide is present in the paint composition, the Cu₂O content is preferably 1-40% by solids volume, such as in the range of 5-35% by solids volume of the paint composition. When expressed by wet weight of the paint composition, and when cuprous oxide is present, the Cu₂O content is preferably at least 5% by wet weight, such as in the range of 10-75% by wet weight of the paint composition.

The pigments phase may further include pigment-like ingredients such as fillers.

Examples of fillers are calcium carbonate, dolomite, talc, mica, barium sulfate, kaolin, silica (including pyrogenic silica, colloidal silica, fumed silica, etc.), perlite, magnesium oxide, calcite and quartz flour, molecular sieves, synthetic zeolites, calcium silicophosphate, hydrated aluminium silicate (bentonite), organo-midified clays, anhydrous gypsum, etc. These materials are characterised in that they do not render the final paint coat non-translucent and therefore do not contribute significantly to hide any material below the final paint coat.

It should be noted that some of the fillers (and pigments) may provide certain advantageous properties of the types provided by the additives of the binder phase (e.g. as stabilizers against moisture, dehydrating agents, water scavengers, thickeners and anti-settling agents, etc.), however for the purpose of the present application with claims, such particulate materials are to be construed as being part of the pigment phase.

Examples of fibres are e.g. those generally and specifically described in WO 00/77102, which is hereby incorporated by reference.

In order for a certain particle to be considered as a fibre within the present context, the ratio between the greatest dimension and the smallest dimension perpendicular to the length dimension in substantially all points along the longitudinal axis (the length dimension—longest dimension) should not exceed 2.5:1, preferably not exceeding 2:1. Furthermore, the ratio between the longest dimension and the average of the two shortest dimensions should be at least 5:1. Thus, fibres are characterised of having one long dimension and two short dimension, where the long dimension is substantially longer than the two short dimensions (typically by an order of magnitude, or even more), and the two short dimensions are substantially equal (of the same order of magnitude). For completely regular fibres, i.e. fibres having a cylindrical shape, it is evident how to determine the “length” (longest dimension) and the two (identical) shortest dimensions. For more irregular fibres, it is believed that the relationship between the dimensions can be evaluated by the following hypothetical experiment: A regular, right-angled box is constructed around the fibre. The box is constructed so as to have the smallest possible volume, as it should fully comprise the fibre. To the extent that the fibre is curved, it is (again hypothetically) assumed that the fibre is flexible so that the volume of the hypothetical box can be minimised by “bending” the fibre. In order for the “fibre” to be recognised as such in the present context, the ratio between the two smallest dimensions of the box should be at the most 2.5:1 (preferably 2:1) and the ratio between the longest dimension of the box and the average of the to smallest dimensions of the box should be at least 5:1.

At present, especially preferred are mineral fibres such as mineral-glass fibres, wollastonite fibres, montmorillonite fibres, tobermorite fibres, atapulgite fibres, calcined bauxite fibres, volcanic rock fibres, bauxite fibres, rockwool fibres, and processed mineral fibres from mineral wool.

When present, the concentration of the fibres is normally in the range of 0.5-15%, e.g. 1-10% by solids volume of the paint composition.

When related to the total composition (wet weight), and when present, the concentration of the fibres is normally in the range of 0.1-20%, e.g. 0.5-10%, by wet weight of the paint composition.

It should be understood that the above ranges refer to the total amount of fibres, thus, in the case where two or more fibre types are utilised, the combined amounts should fall within the above ranges.

The paint composition may also comprise one or more antifouling agents as is customary within the field. Examples of antifouling agents are: metallo-dithiocarbamates such as bis(dimethyldithiocarbamato)zinc, ethylene-bis(dithiocarbamato)zinc, ethylene-bis(dithio-carbamato)manganese, and complexes between these; bis(1-hydroxy-2(1H)-pyridine-thionato-O,S)-copper (Copper Omadine); copper acrylate; bis(1-hydroxy-2(1H)-pyridine-thionato-O,S)-zinc (Zinc Omadine); phenyl(bispyridyl)-bismuth dichloride; metal salts such as cuprous thiocyanate, basic copper carbonate, copper hydroxide, barium metaborate, and copper sulphide; heterocyclic nitrogen compounds such as 3a,4,7,7a-tetrahydro-2-((trichloromethyl)-thio)-1H-isoindole-1,3(2H)-dione, pyridine-triphenylborane, 1-(2,4,6-trichlorophenyl)-1H-pyrrole-2,5-dione, 2,3,5,6-tetrachloro-4-(methylsulfonyl)-pyridine, 2-methylthio-4-tert-butylamino-6-cyclopropylamine-s-triazlne, and quinoline derivatives; heterocyclic sulfur compounds such as 2-(4-thiazolyl)benzimidazole, 4,5-dichloro-2-n-octyl-4-isothiazolin-3-one, 4,5-dichloro-2-octyl-3(2H)-isothiazoline, 1,2-benzisothiazolin-3-one, and 2-(thiocyanatomethylthio)-benzothiazole; urea derivatives such as N-(1,3-bis(hydroxymethyl)-2,5-dioxo-4-imidazolidinyl)-N,N′-bis(hydroxymethyl)urea, and N-(3,4-dichlorophenyl)-N,N-dimethylurea, and N,N-dimethylchlorophenylurea; amides or imides of carboxylic acids; sulfonic acids and of sulfenic acids such as 2,4,6-trichlorophenyl maleimide, 1,1-dichloro-N-((dimethylamino)sulfonyl)-1-fluoro-N-(4-methylphenyl)-methanesulfenamide, 2,2-dibromo-3-nitrilo-propionamide, N-(fluorodichloromethylthio)-phthalimide, N,N-dimethyl-N′-phenyl-N′-(fluorodichloromethylthio)-sulfamide, and N-methylol formamide; salts or esters of carboxylic acids such as 2-((3-iodo-2-propynyl)oxy)-ethanol phenylcarbamate and N,N-didecyl-N-methyl-poly(oxyethyl)ammonium propionate; amines such as dehydroabiethylamines and cocodimethylamine; substituted methane such as di(2-hydroxy-ethoxy)methane, 5,5′-dichloro-2,2′-dihydroxydiphenylmethane, and methylene-bisthiocyanate; substituted benzene such as 2,4,5,6-tetrachloro-1,3-benzenedicarbonitrile, 1,1-dichloro-N-((dimethylamino)-sulfonyl)-1-fluoro-N-phenylmethanesulfenamide, and 1-((diiodomethyl)sulfonyl)-4-methyl-benzene; tetraalkyl phosphonium halogenides such as tri-n-butyltetradecyl phosphonium chloride; guanidine derivatives such as n-dodecylguanidine hydrochloride; disulfides such as bis-(dimethylthiocarbamoyl)-disulfide, tetramethylthiuram disulfide; imidazole containing compound, such as medetomidine; 2-(p-chlorophenyl)-3-cyano-4-bromo-5-trifluoromethyl pyrrole and mixtures thereof.

Presently, it is preferred that the antifouling agent is an agent that does not comprise tin.

In one preferred embodiment the paint composition comprises an antifouling agent selected from the group consisting of pyridine-triphenylborane, 2-(p-chlorophenyl)-3-cyano-4-bromo-5-trifluoromethyl pyrrole and imidazole containing compounds, such as medetomidine.

The total amount of the antifouling agent(s), if present, is typically in the range of up to 30%, such as 0.05-25%, by solids volume of the paint composition, e.g. 0.05-20% by solids volume of the paint composition.

When related to the total weight of the paint composition, the total amount of the antifouling agent(s), if present, is typically in the range of 0-40%, such as 0.05-30%, by wet weight of the paint composition, e.g. 0.05-20% by wet weight of the paint composition. In certain high solids embodiments, the total amount of the antifouling agent(s), if present, is normally in the range of 0-50%, e.g. 0.05-25%, by wet weight of the paint composition.

### The Binder Phase

The binder phase of the paint composition forms the paint film upon drying and thereby corresponds to the continuous phase of the final (dry) paint coat.

Virtually all binder systems conventionally used in self-polishing paint compositions may be used as the binder phase of the present paint composition. It is also found that with respect to the relative amounts of binder system vs. pigments/fillers/etc., only minor modifications (optimizations) may be necessary in order to obtain suitable polishing rates.

For the purpose of illustrating the scope of the present invention with respect to possible types of binder systems, a number of examples of binder systems for marine purposes and yacht purposes, respectively, are provided in the following.

For yacht purposes it is believed that, the following types of constituents within the binder system are especially interesting: (natural) rosin, rosin derivatives, disproportionated rosin, partly polymerised rosin, hydrogenated rosin, gum rosin, disproportionated gum rosin, acrylic resins, polyvinyl methyl ether, and vinyl acetate-vinychloride-ethylene terpolymers. Such constituents may also be present in binder systems for marine purposes.

For marine purposes, it is believed that non-aqueous dispersion binder systems, polyoxalates, silylated acrylate binder systems and metal acrylate binder system represent currently very interesting variants. These binder systems will—for illustrative purposes—be describe in further detail in the following.

### Non-Aqueous Dispersion Binder System

The terms “non-aqueous dispersion resin”, “NAD” and similar expressions are intended to mean a shell-core structure that includes a resin obtained by stably dispersing a high-polarity, high-molecular weight resin particulate component (the “core component”) into a non-aqueous liquid medium in a low-polarity solvent using a high-molecular weight component (the “shell component”).

From the aspect of antifouling property of the final paint coat, shell components such as an acrylic resin or a vinyl resin may be used.

As the core component, a copolymer of an ethylenically unsaturated monomer having a high polarity is generally applicable.

Preferably the core component of the non-aqueous dispersion-type resin has free acid groups or silyl ester groups that are convertible into the acid group by hydrolysis in sea water or combinations thereoff. Preferably 5-75% by weight, e.g. 5-60% by weight or 7-50% by weight, of the monomers of the core polymer should carry free acid groups or silyl ester groups or combinations thereof. As the free acid groups will have direct influence on the properties of the paint formulation, whereas the silyl ester groups will only have influence after hydrolysis in seawater, it is presently preferred to have an overweight of free acid groups.

Examples of silyl ester monomers are silyl esters of acrylic or methacrylic acid.

The dry weight ratio of the core component to the shell component in the NAD resin is not especially limited, but is normally in the range of 90/10 to 10/90, preferably 80/20 to 25/75, such as 60/40 to 25/75.

### Polyoxalate Binder Systems

Another interesting class of binders is the one based on polyoxalates, e.g. those disclosed in WO 2009/100908.

The polyoxalates may be linear or branched polymers. It is typically a copolymer, e.g. a random copolymer or block copolymer. The repeating units of the polyoxalate can be saturated and/or unsaturated aliphatic and/or cycloaliphatic units and/or aromatic units. The repeating units can be unsubstituted or substituted. It will be appreciated that the polyoxalate comprises at least two oxalate units, preferably at least 5 oxalate units, e.g. at least 8 oxalate units. The polyoxalate will preferably be formed from the polymerisation of at least one oxalate monomer and at least one diol monomer.

The polyoxalates can be prepared by condensation polymerisation using any of various methods known and used in the art. Examples of common polycondensation reactions include direct esterification reaction between oxalic acid and diols; transesterification reaction between dialkyl oxalates and diols; reaction in solution between oxalyl chloride with diols; and interfacial condensation reaction between oxalyl chloride and diols or alkali salts of diols or between alkali salts of oxalic acid, such as sodium oxalate or potassium oxalate, and diols. The polycondensation reactions can be carried out as melt or in solution. The polymerisation can be performed under melt polycondensation condition or in solution.

The oxalate monomer used in the polymerisation reaction may be an ester of oxalic acid, especially a diester. Esters may be alkyl esters, alkenyl esters or aryl esters. Examples of suitable dialkyl oxalates for the preparation of polyoxalates include dimethyl oxalate, diethyl oxalate, dipropyl oxalate and dibutyl oxalate. Dialkyl oxalates are preferred. Examples of diols for the preparation of polyoxalates include saturated aliphatic and saturated cycloaliphatic diols, unsaturated aliphatic diols or aromatic diols. Linear or branched saturated aliphatic diols are preferred. The above mentioned diols can be used alone or in combination of two or more diols. Preferably a mixture of two or more diols is used to manufacture the polyoxalates. Branching in polymers and “star” shaped polymers are examples of useful structural variables that can be used advantageously to modify polymer properties such as solubility in organic solvents, miscibility in polymer blends and mechanical properties.

See further in WO 2009/100908 for details about such binder components.

### Silylated Acrylate Binder System

The term silylated acrylate is intended to cover silylated acrylate co-polymers having at least one side chain bearing at least one terminal group of the general formula I:

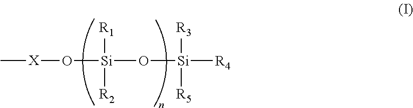

wherein n is 0 or an integer of 1 or more and X, R₁, R₂, R₃, R₄ and R₅ are as defined above.

R₁-R₅ are each groups selected from the group consisting of C₁₋₂₀-alkyl, C₁₋₂₀-alkoxy, phenyl, optionally substituted phenyl, phenoxy and optionally substituted phenoxy. With respect to the above formula I it is generally preferred that each of the alkyl and alkoxy groups has up to about 5 carbon atoms (C₁₋₅-alkyl). Illustrative examples of substituents for the substituted phenyl and phenoxy groups include halogen, C₁₋₅-alkyl, C₁₋₅-alkoxy or C₁₋₁₀-alkylcarbonyl. As indicated above, R₁-R₅ may be the same or different groups.

The co-polymers preferably have weight average molecular weights in the range of 1,000-1,500,000, such as in the range of 5,000-1,500,000, e.g. in the range of 5,000-1,000,000, in the range of 5,000-500,000, in the range of 5,000-250,000, or in the range of 5,000-100,000.

With respect to the triorganosilyl group, i.e. the —Si(R₃)(R₄)(R₅) group, shown in the above formulae I, R₃, R₄ and R₅ may be the same or different, such as C₁₋₂₀-alkyl (e.g. methyl, ethyl, propyl, butyl, cycloalkyl such as cyclohexyl and substituted cyclohexyl); aryl (e.g., phenyl and naphthyl) or substituted aryl (e.g., substituted phenyl and substituted naphthyl). Examples of substituents for aryl are halogen, C₁₋₁₈-alkyl, C₁₋₁₀-acyl, sulphonyl, nitro, and amino.

Specific examples of suitable methacrylic acid-derived monomers bearing at least one terminal group of the general formula I include trimethylsilyl(meth)acrylate, triethyl-silyl(meth)acrylate, tri-n-propylsilyl(meth)acrylate, triisopropylsilyl(meth)acrylate, tri-n-butylsilyl(meth)acrylate, triisobutylsilyl(meth)acrylate, tri-tert-butylsilyl(meth)acrylate, tri-n-amylsilyl(meth)acrylate, tri-n-hexylsilyl(meth)acrylate, tri-n-octylsilyl(meth)acrylate, tri-n-dodecylsilyl(meth)acrylate, triphenylsilyl(meth)acrylate, tri-p-methylphenylsilyl(meth)-acrylate, tribenzylsilyl(meth)acrylate, ethyldimethylsilyl(meth)acrylate, n-butyldimethylsilyl(meth)acrylate, diisopropyl-n-butylsilyl(meth)acrylate, n-octyldi-n-butylsilyl(meth)acrylate, disopropylstearylsilyl(meth)acrylate, dicyclohexylphenylsilyl(meth)acrylate, t-butyldiphenyl-silyl(meth)acrylate, and lauryldiphenylsilyl(meth)acrylate.

The silylated acrylate may comprise monomer units with a terminal group of the general formula I (as discussed above) in combination with a second monomer B of the general formula II:

Y—(CH(R_{A})—CH(R_{B})—O)ₚ—Z (II)

wherein Z is a C₁₋₂₀-alkyl group or an aryl group; Y is an acryloyloxy group, a methacryloyl-oxy group, a maleinoyloxy group or a fumaroyloxy group; R_{A} and R_{B} are independently selected from the group consisting of hydrogen, C₁₋₂₀-alkyl and aryl; and p is an integer of 1 to 25.

Specific examples of monomer B which has a (meth)acryloyloxy group in a molecule include methoxyethyl(meth)acrylate, ethoxyethyl(meth)acrylate, propoxyethyl(meth)acrylate, butoxyethyl(meth)acrylate, hexoxyethyl(meth)acrylate, methoxydiethylene glycol(meth)acrylate, methoxytriethylene glycol(meth)acrylate, ethoxydiethylene glycol(meth)acrylate, and ethoxytriethylene glycol(meth)acrylate.

The silylated acrylate may comprise a co-polymer having monomer units with a terminal group of the general formula I (as discussed above) in combination with a second monomer C of the general formula III:

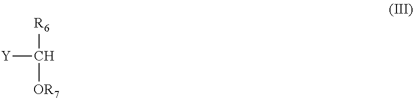

wherein Y is an acryloyloxy group, a methacryloyloxy group, a maleinoyloxy group or a fumaroyloxy group, and both of R₆ and R₇ are C₁₋₁₂-alkyl.

With respect to other monomers co-polymerisable with the above-mentioned monomers, use may be made of various vinyl monomers.

Alternatives of the silyl ester-type binders are the low molecular weight variants disclosed in WO 2005/005516.

Typically the binder is a silyl ester copolymer is a copolymer comprising at least one side chain bearing at least one terminal group of the formula:

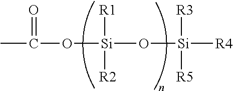

wherein n is 0 or an integer of 1 to 50, and R1, R2, R3, R4, and R5 are each independently selected from the group consisting of optionally substituted C₁₋₂₀-alkyl, optionally substituted C₁₋₂₀-alkoxy, optionally substituted aryl, and optionally substituted aryloxy, and having a weight-average molecular weight less of than 20,000, a polydispersity of less than 3.0, a glass transition temperature below 90° C., with less than 70 weight percent of said silyl ester copolymer consisting of side chains having a silyl ester functionality. See in WO 2005/005516 for further details about such binder components.

### Metal Acrylate Binder System

The term metal acrylate is intended to cover co-polymers having at least one side chain bearing at least one terminal group of the general formula IV

—X—O-M-(L)ₙ (IV)

wherein X is

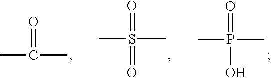

M is a metal having a valency of 2 or more;
n is an integer of 1 or more with the proviso that n+1 equals the metal valency;
L is an organic acid residue and each L is independently selected from the group consisting of wherein R₄ is a monovalent organic residue, or L is —OH or combinations thereof;
R₃ is hydrogen or a hydrocarbon group having from 1 to 10 carbon atoms.

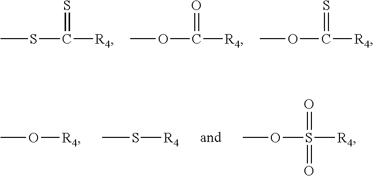

Examples of monomers having a terminal group of the general formulae IV (shown above) are acid-functional vinyl polymerisable monomers, such as methacrylic acid, acrylic acid, p-styrene sulfonic acid, 2-methyl-2-acrylamide propane sulfonic acid, methacryl acid phosphoxy propyl, methacryl 3-chloro-2-acid phosphoxy propyl, methacryl acid phosphoxy ethyl, itaconic acid, maleic acid, maleic anhydride, monoalkyl itaconate (e.g. methyl, ethyl, butyl, 2-ethyl hexyl), monalkyl maleate (e.g. methyl, ethyl, butyl, 2-ethyl hexyl; half-ester of acid anhydride with hydroxyl containing polymerisable unsaturated monomer (e.g. half-ester of succinic anhydride, maleic anhydride or phthalic anhydride with 2-hydroxy ethyl methacrylate.

The above-mentioned monomers may be co-polymerised (in order to obtain the co-polymer with one or more vinyl polymerisable monomers. Examples of such vinyl polymerisable monomers are methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethyl hexyl acrylate, 2-ethyl hexyl methacrylate, methoxy ethyl methacrylate, styrene, vinyl toluene, vinyl pyridine, vinyl pyrolidone, vinyl acetate, acrylonitrile, methacrylonitrile, dimethyl itaconate, dibutyl itaconate, di-2-ethyl hexyl itaconate, dimethyl maleate, di(2-ethyl hexyl)maleate, ethylene, propylene and vinyl chloride.

With respect to the metal (M), any metal having a valency of 2 or more may be used. Specific examples of suitable metals include Ca, Mg, Zn, Cu, Ba, Te, Pb, Fe, Co, Ni, Bi, Si, Ti, Mn, Al and Sn. Preferred examples are Co, Ni, Cu, Zn, Mn, and Te, in particular Cu and Zn. When synthesising the metal-containing co-polymer, the metal may be employed in the form of its oxide, hydroxide or chloride. The metal acrylate co-polymer may be prepared as described in e.g. EP 0 471 204 B1, EP 0 342 276 B1 or EP 0 204 456 B1.

It should be noted that in the resulting co-polymer, not all the organic acid side groups need to contain a metal ester bond; some of the organic acid side groups may be left un-reacted in the form of free acid, if desired.

The weight average molecular weight of the metal-containing co-polymer is generally in the range of from 1,000 to 150,000, such as in the range of from 3,000 to 100,000, preferably in the range of from 5,000 to 60,000.

### Further Binder Components

The above-mentioned binder systems (e.g. the non-aqueous dispersion binder system and the silylated acrylate binder system) may include therein—as a part of the binder system—one or more further binder components. It should be understood that the binder components mentioned below may also constituted the binder system, cf. the general presentation of the binder system.

Examples of such further binder components are: rosin and rosin derivatives (see definition further above) including metal salts of rosin, oils such as linseed oil and derivatives thereof, castor oil and derivatives thereof, soy bean oil and derivatives thereof; and other polymeric binder components such as saturated polyester resins; polyvinylacetate, polyvinylbutyrate, polyvinylchloride-acetate, copolymers of vinyl acetate and vinyl isobutyl ether; vinylchloride; copolymers of vinyl chloride and vinyl isobutyl ether; alkyd resins or modified alkyd resins; hydrocarbon resins such as petroleum fraction condensates; chlorinated polyolefines such as chlorinated rubber, chlorinated polyethylene, chlorinated polypropylene; styrene copolymers such as styrene/butadiene copolymers, styrene/methacrylate and styrene/acrylate copolymers; acrylic resins such as homopolymers and copolymers of methyl methacrylate, ethyl methacrylate, n-butyl methacrylate, isobutyl methacrylate and isobutyl methacrylate; hydroxy-acrylate copolymers; cyclised rubbers; epoxy esters; epoxy urethanes; polyurethanes; epoxy polymers; etc., as well as copolymers thereof.

It should be understood that the group of further binder components may include polymeric flexibilisers such as those generally and specifically defined in WO 97/44401 that is hereby incorporated by reference.

Such further binder components typically constitutes 0-10% by solids volume of the paint composition. The dry matter of such further binder components is typically 0-10% by wet weight of the paint composition.

### Further Constituents of the Binder Phase

The binder phase (i.e. the phase corresponding to the continuous phase of the final (dry) paint coat) may—besides the binder system (including the further binder components)—of course also include dyes, additives and solvents, as well as other suitable constituents to be included in the binder phase of paint compositions.

Examples of dyes are 1,4-bis(butylamino)anthraquinone and other anthraquinone derivatives; toluidine dyes etc.

Examples of additives are plasticizers such as chlorinated paraffin; phthalates such as dibutyl phthalate, benzylbutyl phthalate, dioctyl phthalate, diisononyl phthalate and diisodecyl phthalate; phosphate esters such as tricresyl phosphate, nonylphenol phosphate, octyl-oxipoly(ethyleneoxy)ethyl phosphate, tributoxyethyl phosphate, isooctylphosphate and 2-ethylhexyl diphenyl phosphate; sulfonamides such as N-ethyl-p-toluensulfonamide, alkyl-p-toluene sulfonamide; adipates such as bis(2-ethylhexyl)adipate), diisobutyl adipate and di-octyladipate; phosphoric acid triethyl ester; butyl stearate; sorbitan trifoliate; and epoxidised soybean oil; surfactants such as derivatives of propylene oxide or ethylene oxide such as alkylphenol-ethylene oxide condensates; ethoxylated monoethanolamides of unsaturated fatty acids such as ethoxylated monoethanolamides of linoleic acid; sodium dodecyl sulfate; alkylphenol ethoxylates; and soya lecithin; wetting agents and dispersants; defoaming agents such as silicone oils; stabilisers such as stabilisers against light and heat, e.g. hindered amine light stabilisers (HALS),2-hydroxy-4-methoxybenzophenone, 2-(5-chloro-(2H)-benzotriazol-2-yl)-4-methyl-6-(tert-butyl)phenol, and 2,4-ditert-butyl-6-(5-chlorobenzotriazol-2-yl)phenol; stabilisers against moisture or water scavengers, substituted isocyanates, substituted silanes and ortho formic acid triethyl ester; stabilisers against oxidation such as butylated hydroxyanisole; butylated hydroxytoluene; propylgallate; tocopherols; 2,5-di-tert-butyl-hydroquinone; L-ascorbyl palmitate; carotenes; vitamin A; inhibitors against corrosion such as aminocarboxylates, ammonium benzoate, barium/-calcium/zinc/magnesium salts of alkylnaphthalene sulfonic acids, zinc phosphate; zinc metaborate; coalescing agents such as glycols, 2-butoxy ethanol, and 2,2,4-trimethyl-1,3-pentanediol monoisobutyrate; and thickeners and anti-settling agents such as aluminiumtristearate, aluminiummonostearate, ricinus oil, xanthan gum, salicylic acid, hydrogenated castor oil, polyamide waxes and polyethylene waxes. Dehydrating agents such as orthopropionic acid ester, orthoformic acid ester, orthoacetic acid ester, alkoxysilane, alkyl silicates like tetra ethyl ortosilicate, or isocyanates.

It is preferred that the paint compositions comprise dyes and additives in a cumulative amount of 0-20%, e.g. 1-20%, by solids volume of the paint composition.

When related to the total weight of the paint composition, it is preferred that the paint compositions comprise dyes and additives in a cumulative amount of 0-10%, e.g. 1-10%, by wet weight of the paint composition.

Examples of solvents are alcohols such as methanol, ethanol, propanol, isopropanol, butanol, isobutanol and benzyl alcohol; aliphatic, cycloaliphatic and aromatic hydrocarbons such as white spirit, cyclohexane, toluene, xylene and naphtha solvent; ketones such as methyl ethyl ketone, acetone, methyl isobutyl ketone, methyl isoamyl ketone, diacetone alcohol and cyclo-hexanone; ether alcohols such as 2-butoxyethanol, propylene glycol monomethyl ether, ethylene glycol monoethyl ether, ethyl ether and butyl diglycol; esters such as ethyl acetate, propyl acetate, methoxypropyl acetate, n-butyl acetate and 2-ethoxyethyl acetate; chlorinated hydrocarbons such as methylene chloride, tetrachloroethane and trichloroethylene; and mixtures thereof.

When related to the total weight of the paint composition, it is preferred that the paint compositions comprise one or more solvents in a cumulative amount of 0-60%, e.g. 10-60%, by wet weight of the paint composition.

In the present context the term “% by wet weight” is intended to mean the weight/weight percentage of the wet matter of the paint composition. It should be understood that solvents are included.

In the present context the term “% by solids volume” is intended to mean the volume/volume percentage of the solid (i.e. non-volatile) matter of the paint composition. It should be understood that any solvents (i.e. volatiles) are disregarded.

### Preparation of the Solid Particles

The solid particles may be prepared by encapsulation methods such as micro encapsulation, where the end result is small particle composed of one material (core/internal phase/fill) confined within one or more uniform wall(s) of a different material(s) (shell/membrane). Micro capsules can be prepared by physical methods such as pan coating, air-suspension coating, centrifugal extrusion, spray-drying, and the use of vibrational nozzle techniques to prepare core-shell encapsulation or microgranulation. Or they can be prepared by physico-chemical methods such as ionotropic gelation, coacervation. Also, chemical methods can be applied; these are interfacial polycondensation, interfacial cross-linking, in-situ polymerisation, and matrix polymerisation. Alternatively the solid particles may be prepared by entrapment of the one or more rosin constituents in a matrix that allows for contact between the entrapped material and the surroundings, but effectively hinders diffusion or dissolution of the entrapped material in the solvent. Solid particles based on entrapment may be prepared by polymerisation of material in-situ in a porous structure, such as an aerogel, a xerogel, a cryogel or an aeromosil. The solid particles may also be prepared by introducing the one or more rosin constituents into a porous structure by immersing a suitable porous material in a melt or solution of the one or more rosin constituents. Diffusion and capillary forces will then drive the one or more rosin constituents into the pores of the porous material.

Production of silica aerogels is typically done by the sol-gel process. First a gel is created in solution and then the liquid is carefully removed to leave the aerogel intact. The first step is the creation of a colloidal suspension of solid particles known as a “sol”. Silica aerogel is made by the creation of colloidal silica. The process starts with a liquid alcohol like ethanol which is mixed with a silicon alkoxide precursor, for example tetramethyl orthosilicate (TMOS) or tetraethyl orthosilicate (TEOS). A hydrolysis reaction forms particles of silicon dioxide forming a sol solution. The oxide suspension begins to undergo condensation reactions which result in the creation of metal oxide bridges (either M-O-M, “oxo” bridges or M-OH-M, “ol” bridges) linking the dispersed colloidal particles.

When this interlinking has stopped the flow of liquid within the material, this is known as a gel. This process is known as gelation. These reactions generally have moderately slow reaction rates, and as a result either acidic or basic catalysts are used to improve the processing speed. Basic catalysts tend to produce more transparent gels with less shrinkage.

The removal of the liquid from a true aerogel involves special processing. Gels where the liquid is allowed to evaporate normally are known as xerogels. As the liquid evaporates, forces caused by surface tensions of the liquid-solid interfaces are enough to destroy the fragile gel network. As a result xerogels cannot achieve the high porosities and instead peak at lower porosities and exhibit large amounts of shrinkage after drying.

### EMBODIMENTS OF THE INVENTION

In one embodiment, the present invention provides a self-polishing antifouling paint composition comprising:

50-75% by solids volume of the composition of a binder system,
25-50% by solids volume of the composition of a pigment phase, said pigment phase comprising solid particles consisting of a rosin-modified polymer entrapped in a matrix in an amount of 1-49% by solids volume, and a metallo-organic or organic antifouling agent in an amount of 0.05-20% by solids volume; and
optionally one or more solvents.

In one particular embodiment, the present invention provides a self-polishing antifouling paint composition comprising:

50-75% by solids volume of the composition of a binder system,
25-50% by solids volume of the composition of a pigment phase, said pigment phase comprising solid particles consisting of rosin or rosin derivatives encapsulated in a matrix in an amount of 1-49% by solids volume, and an inorganic, metallo-organic or organic antifouling agent in an amount of 0.05-20% by solids volume; and
optionally one or more solvents.

In another embodiment, the present invention provides a self-polishing antifouling paint composition comprising:

50-75% by solids volume of the composition of a binder system,
25-50% by solids volume of the composition of a pigment phase, said pigment phase comprising solid particles consisting of rosin or rosin derivatives entrapped in a silica aerogel matrix in an amount of 1-49% by solids volume, and a metallo-organic or organic antifouling agent in an amount of 0.05-20% by solids volume; and
optionally one or more solvents.

### Preparation of the Paint Composition

The present invention also provides a method for the preparation of the self-polishing antifouling paint composition as defined herein, said method comprising the step of bringing solid particles consisting of one or more rosin constituents entrapped or encapsulated in a matrix in admixture with a binder system and one or more constituents selected from dyes, additives, solvents, pigments, fillers, fibres and anti-fouling agents, and any other suitable constituents to be included in either the binder phase or the pigment phase of paint compositions.

The paint composition of the present invention is prepared usually by mixing and dispersing the above components all at once or in a divided fashion by a conventional apparatus for producing paint composition (paints), such as a ball mill, a pearl mill, a three-roll mill, a high speed disperser. The paint compositions according to the invention, optionally containing fibres, may be filtrated using bag filters, patron filters, wire gap filters, wedge wire filters, metal edge filters, EGLM turnoclean filters (ex Cuno), DELTA strain filters (ex Cuno), and Jenag Strainer filters (ex Jenag), or by vibration filtration. The paint composition of the present invention thus prepared may be coated as it is or after having the viscosity adjusted by a diluting solvent, on a ship or a maritime structure having a rust preventive coating material coated thereon, by e.g. airless spray-coating, air spray-coating, roller coating or brush coating. The exact technique chosen depends upon the object to be protected and also upon the particular composition (such as its viscosity etc.) and upon the particular situation. Preferred applications techniques are spraying and by means of a brush or a roller.

Preferably the solid particles consisting of one or more rosin constituents entrapped or encapsulated in a matrix are added to the paint composition as powders.

Depending on the application technique, it is desirable that the paint composition comprises solvent(s) so that the solids volume ratio (SVR) is in the range of 30-100%, such as 30-70%.

The invention further relates to a marine structure coated with one or several layers, in particular successive layers, of a paint composition as defined hereinabove.

The paint composition according to the invention may be applied to a marine structure to be protected in one or several successive layers, typically 1 to 5 layers, preferably 1 to 3 layers. The dry film thickness (DFT) of the coating applied per layer will typically be 10 to 300 μm, preferably 20 to 250 μm, such as 40 to 200 μm. Thus, the total dry film thickness of the coating will typically be 10 to 900 μm, preferably 20 to 750 μm, in particular 40 to 600 μm, such as 80 to 400 μm.

The marine structure to which the paint composition according to the invention may be applied to may be any of a wide variety of solid objects that come into contact with water, for example vessels (including but not limited to boats, yachts, motorboats, motor launches, ocean liners, tugboats, tankers, container ships and other cargo ships, submarines (both nuclear and conventional), and naval vessels of all types); pipes; shore and off-shore machinery, constructions and objects of all types such as piers, pilings, bridge substructures, floatation devices, underwater oil well structures etc; nets and other mariculture installations; cooling plants; and buoys; and is especially applicable to the hulls of ships and boats and to pipes.

Prior to the application of a paint composition to a marine structure, the marine structure may first be coated with a primer-system which may comprise several layers and may be any of the conventional primer systems used in connection with application of paint compositions to marine structures. Thus, the primer system may include an anti-corrosive primer optionally followed by a layer of an adhesion-promoting primer.

The above-mentioned primer system may, for example, be a combination of an epoxy resin having an epoxy equivalent of from 160 to 600 with its curing agent (such as an amino type, a carboxylic acid type or an acid anhydride type), a combination of a polyol resin with a polyisocyanate type curing agent, or a coating material containing a vinyl ester resin, an unsaturated polyester resin or the like, as a binder system, and, if required, further containing a thermoplastic resin (such as chlorinated rubber, an acrylic resin or a vinyl chloride resin), a curing accelerator, a rust preventive pigment, a colouring pigment, an extender pigment, a solvent, a trialkoxysilane compound, a plasticizer, an additive (such as an antisagging agent or a precipitation preventive agent), or a tar epoxy resin type coating material, as a typical example.

### Use and Method

The present invention further provides the use of solid particles consisting of one or more rosin constituents entrapped or encapsulated in a matrix in a paint composition to provide self-polishing properties to said paint composition.

The present invention further provides a method for providing a self-polishing effect of a paint composition, the method comprising the step of incorporating into the paint composition solid particles consisting of one or more rosin constituents entrapped or encapsulated in a matrix.

The specifications above, including the specifications regarding the solid particles, also apply in connection with the use and the method described above.

### General Remarks

Although the present description and claims occasionally refer to a constituent (e.g. “a pigment”, “a filler”, “a binder component”), etc., it should be understood that the paint compositions defined herein may comprise one, two or more types of the individual constituents. In such embodiments, the total amount of the respective constituent should correspond to the amount defined above for the individual constituent.

The “(s)” in the expressions: pigment(s), fillers(s), agent(s), etc. indicates that one, two or more types of the individual constituents may be present.

On the other hand, when the expression “one” is used, only one (1) of the respective constituent is meant to be present.

### EXAMPLES

### Determination of Weight Average Diameter of Solids Particles

The average particle size and the particle size distribution of the solid particles can be established using a Malvern Mastersizer 2000 from Malvern Instruments, and a Hydro 2000G sample disperser. Measurements may be done on a suspension of the solid particles in organic solvents such as ethanol or xylene.

### Polishing Rate Test

Polishing and leaching characteristics are measured using a rotary set-up similar to the one described by Kiil et al. (Kiil, S, Weinell, C E, Yebra, D M, Dam-Johansen, K, “Marine biofouling protection: design of controlled release antifouling paints.” In: Ng, K M, Gani, R, Dam-Johansen, K (eds.) Chemical Product Design; Towards a Perspective Through Case Studies, 23IDBN-13: 978-0-444-52217-7. Part II (7), Elsevier. (2006)). The set-up consists of a rotary rig, which has two concentric cylinders with the inner cylinder (rotor, diameter of 0.3 m and height 0.17 m) capable of rotation. The cylinder pair is immersed in a tank containing about 400-500 litres of Artificial Seawater (cf. Table 1).

TABLE 1
Composition of Artificial Seawater

| Salt | Concentration in g/L |
|---|---|
| NaCl | 32 |
| MgSO₄•7H₂O | 14 |
| NaHCO₃ | 0.2 |

The tank is fitted with baffles to break the liquid flow, which enhances turbulence and enables faster mixing of the species released from the paints and enhance heat transfer from a thermostating system. The purpose of using two cylinders is to create a close approximation to couette flow (flow between two parallel walls, where one wall moves at a constant velocity). The rotor is operated at 20 knots at 25° C. (unless otherwise specified), and the pH is adjusted frequently to 8.2 using 1 M sodium hydroxide or 1 M hydrochloric acid.

Samples are prepared using overhead transparencies (3M PP2410) that are primed using two-component paint (Hempadur 45182 ex Hempel A/S) applied using a Doctor Blade applicator with a gap size of 200 μm. Coating samples are applied adjacent to each other using a Doctor Blade applicator with a gap of 500 μm. After drying for 1 day, the coated transparency is cut in strips of 2 cm resulting in eight samples of 1.5×2 cm² on a long (21 cm) strip. The strips are mounted on the rotor, and left to dry for a week.

After one week, the test is initiated, and during the experiment, a sample is removed approximately each month in order to determine the polishing rate and the leaching depth. The samples are dried for three days at ambient conditions, after which they are cut in half and cast in paraffin. The internal front of the sample is planed off before total film thickness and leached layer thickness is established using light microscopy (coating cross-section inspection).

### Antifouling Property Test in Singapore and Spain

An acrylic test panel (15×20 cm²), sandblasted on one side to facilitate adhesion of the coating, is first coated with 80 μm (DFT) of Hempatex high-build 4633 from Hempel A/S (a system based on chlorinated rubber binders) applied by air spraying. After a minimum drying time of 24 hours in the laboratory at room temperature the test paint is applied with a Doctor Blade type applicator, with four gap sizes with a film width of 80 mm. One coat was applied in a DFT of 90-100 μm. After at least 72 hours drying the test panels are fixed on a rack and immersed in sea water.

In Singapore the panels are immersed in seawater with salinity in the range of 29-31 parts per thousand at a temperature in the range of 29-31° C. In Spain the panels are immersed in the Mediterranean, where the temperature varies between 13 and 25° C. depending on the season.

Every 4-12 weeks, inspection of the panels is made and the antifouling performance is evaluated according to the scale shown in Table 2. One score is given for each of the fouling types: algae and animals.

TABLE 2
Scale for grading the performance of coatings
undergoing static antifouling testing

| Score | Fouled area (%) |
|---|---|
| 0 | 0% fouling |
| 1 | 0-2% fouling |
| 2 | 3-5% fouling |
| 3 | 6-25% fouling |
| 4 | 26-50% fouling |
| 5 | 51-100% fouling |

The fouling species of most relevance are animals. For animal fouling a level of 1 is considered good. For algal fouling, a level of up to grade 2 is acceptable.

Dissolution Rate of Rosin Constituents from Solid Particles in Artificial Seawater

The release rate of rosin from the solid particles may be measured by exposure to artificial seawater under dynamic conditions. The solid is ground using a mortar. Subsequently a suspension of the ground particles is prepared in artificial seawater. The suspension is placed on a stirring table at 25° C. for three weeks the suspension is centrifuged. A sample of the supernatant is taken out, and the concentration of degraded or dissolute particle material in the artificial seawater is measured. Measuring the concentration of rosin in artificial seawater may be done by extracting the rosin into toluene solution containing 0.1% of an internal standard (e.g. 1,4 dicyano butene) for IR quantification. After dispersion of the toluene extraction on potassium bromide pellets, and subsequent evaporation of the toluene at 25° C. In a fume hood, IR spectres can be obtained, and the amount of rosin in the toluene can be established by comparing the area of the characteristic peaks (e.g. 1660 cm⁻¹ for Rosin and 2250 cm⁻¹ for the internal standard). As a reference, hydrogenated rosin (Eastman Foral AX-E Fully hydrogenated rosin) is used, and the release rate of the samples is expressed as a fraction of that of pure rosin.

### Stability of Solid Particles Immersed in Xylene (the Xylene Stability Test)

A lump of approximately 0.5 g of a sample of solid particles is weighed and immersed in at least 5 g of xylene. The container is kept at 25° C. Every 48-36 hours the sample is taken out of the container, dried at 25° C. in a fume hood to constant weight, after which the sample is weighed and again put into at least 5 g of pure xylene. The procedure is repeated for at least 6 days or until a stable weight of the sample has been reached.

### Stability of Solid Particles Immersed in Toluene

The Xylene Stability Test above may alternatively be conducted using toluene.

### Example 1

### Preparation of Silica Aerogel

86.5 mL TMOS (tetramethyl orthosilicate, tetramethoxysilane 985 from Aldrich) is mixed with 400 mL Methanol (reagent grade) on a magnetic stirrer for 15 minutes and 50 mL 0.5% ammonia solution added. After 2 minutes vigorous stirring the gel is allowed to rest unstirred and gel for 15 minutes. 300 g of the prepared gel is cut into pieces and placed in a 500 mL high pressure flow vessel. After slowly letting MeOH flow app 2 mL/minute for several days in order to remove water content, the temperature is raised to 40° C. and the vessel is gradually pressurised with MeOH to 100 bars with a speed of 3 bars/minute. The reactor is flowed with CO₂ at 100 bars pressure and a temperature of 40° C. for 9 hours at a flow rate of 6-7 g CO₂/minut. After this, CO₂ gas is slowly vented off during several hours leaving the dry hydrophilic silica aerogel for collection from the vessel.

For preparation of more hydrophobic aerogels, MTMS (methyltrimethoxysilane) can partly be used as replacement for TMOS using the same procedure as described above.

### Example 2

### Preparation of Rosin-Filled Gel Material

The material produced in example 1 is crushed to produce small lumps below 1 cm³ and placed in a container with an excess of hydrogenated rosin (Eastman Foral AX-E Fully hydrogenated rosin). The container is heated to 140° C. and kept at this temperature for a time not exceeding 4 hours. The filled gel is separated from the molten rosin before cooling. The material is ground to obtain a powder.

### Example 3

### Preparation of Gel-Material Containing Polymerised Rosin

20.25 g hydrogenated rosin is dissolved in 100 mL dry butanone and 72 mg hydroquinone and 360 mg tetramethylammonium bromide are added. A solution of 11.6 g of glycidyl methacrylate is dissolved in 10 mL dry butanone and slowly added to the reaction mixture at room temperature. The reaction mixture is left under nitrogen atmosphere. After stirring for 15 minutes the temperature is raised to 80° C. and the reaction mixture is left for 24 hours.

After cooling the butanone is removed by distillation in vacuum. The waxy yellowish material is redissolved in methylene chloride and washed with a 5% aqueous solution of sodium hydroxide, followed by washing with a brine solution and finally with water. The methylene chloride solution is dried over sodium sulphate and the solvent is removed by vacuum distillation.

An aerogel prepared as described in Example 1 is placed in a container with a solution of the rosin-monomer and a few percent azobisisobyronitrile (AIBN). The solvent is allowed to evaporate, and xylene is added. The suspended material is heated to 85° C. Polymerisation is allowed to take place for 15 minutes before the material is cooled and washed several times with xylene in order to remove unreacted rosin-monomers. The material is ground to obtain a powder. In one example a weight average diameter of 41 μm was obtained.

### Example 4

### Preparation of Paints Compositions

Model paint with encapsulated rosin, having the composition specified below can be prepared by adding the raw materials to a suitable container. A solvent, e.g. xylene or a mixture of xylene and methyl iso-butyl ketone (MIBK), can be added in order to obtain a suitable viscosity. The paint is mixed on a high speed dissolver. Glass pearls are added to crush the pigments to a fineness of grind below 60 μm. The dispersion is ended when a suitable fineness of grind has been obtained, and the temperature to activate the thixotropic agents (additives) has been reached.

| | Reference | Model | Model |
|---|---|---|---|
| | Paint 1 | Paint 3 | Paint 4 |
| | % solids | % solids | % solids |
| | volume | volume | volume |
| Binder phase | | | |
| Binder system comprised of | 57 | 57 | 57 |
| silylated acrylic copolymer solution | | | |
| and rosin | | | |
| Additives | 8 | 8 | 8 |
| Pigment phase | | | |
| Inorganic pigments and fibres | 5 | 5 | 5 |
| (Micronized Natural Red Iron Oxide, | | | |
| OSO NR 839M, Tor Minerals | | | |
| International US, | | | |
| Rockforce ®MS603- | | | |
| Roxul ®1000 Lapinus Fibres BV- | | | |
| Holland) | | | |
| Solid particles with Rosin entrapped | | 7 | |
| in silica aerogel (Example 2) | | | |
| Solid particles with Rosin-modified | | | 7 |
| polymer entrapped in silica aerogel | | | |
| (Example 3) | | | |
| Zinc Oxide Read Seal, Umicore, | 2 | 2 | 2 |
| Holland | | | |
| Copper (I) oxide, Red Copp 97N, | 28 | 21 | 21 |
| Chemet US | | | |
| Total | 100 | 100 | 100 |
| Total Pigment phase | 35 | 35 | 35 |
| Leached layer thickness at steady | 32 | 28 | — |
| state (μm) | | | |
| Polishing rate (μm/10,000 NM) after | 4.4 | 5.9 | — |
| 57,000 NM | | | |
| Initiation of polishing (1000 NM) | 15 | <15 | — |

### Discussion:

It is noted that the replacement of one fourth of the volume of the copper(I) oxide by the solid particles of a silica aerogel having rosin entrapped therein results in an improvement of the initiation of the polishing. In fact, almost immediate polishing was observed for Model Paint 3, contrary to the Reference Paint.

| | Model | Model | Ref. | Model | Ref. | Model | Ref. | Model |
|---|---|---|---|---|---|---|---|---|
| | Paint 5 | Paint 6 | Paint 2 | Paint 7 | Paint 3 | Paint 8 | Paint 4 | Paint 9 |
| | % | % | % | % | % | % | % | % |
| | solids | solids | solids | solids | solids | solids | solids | solids |
| | volume | volume | volume | volume | volume | volume | volume | volume |
| Binder phase | | | | | | | | |
| Binder system | 52 | 52 | 52 | 52 | 56 | 56 | | |
| comprised of | | | | | | | | |
| silylated acrylic | | | | | | | | |
| copolymer | | | | | | | | |
| solution, polyvinyl | | | | | | | | |
| methyl ether and | | | | | | | | |
| rosin | | | | | | | | |
| Binder system | | | | | | | 50 | 50 |
| comprised of | | | | | | | | |
| core/shell, SPD 3- | | | | | | | | |
| 55SS, Dai Nippon | | | | | | | | |
| Toryo CO, LTD, | | | | | | | | |
| acrylic copolymer | | | | | | | | |
| solution and rosin | | | | | | | | |
| Additives | 10 | 10 | 10 | 10 | 9 | 9 | 8 | 8 |
| Pigment phase | | | | | | | | |
| Inorganic pigments | 5 | 5 | 5 | 5 | | | | |
| and fibres | | | | | | | | |
| (Micronized | | | | | | | | |
| Natural Red Iron | | | | | | | | |
| Oxide, Micronox H, | | | | | | | | |
| Promindsa, | | | | | | | | |
| Rockforce ®MS603- | | | | | | | | |
| Roxul ®1000 | | | | | | | | |
| Lapinus Fibres BV - | | | | | | | | |
| Holland) | | | | | | | | |
| Inorganic pigments | | | | | 5 | 5 | | |
| and fibres | | | | | | | | |
| (Titanium dioxide | | | | | | | | |
| Sachtleben R 320, | | | | | | | | |
| Sachtleben | | | | | | | | |
| (Germany), | | | | | | | | |
| Rockforce ®MS603- | | | | | | | | |
| Roxul ®1000 | | | | | | | | |
| Lapinus Fibres BV - | | | | | | | | |
| Holland) | | | | | | | | |
| Inorganic pigments | | | | | | | 11 | 11 |
| and | | | | | | | | |
| fibres (Micronized | | | | | | | | |
| Natural Red Iron | | | | | | | | |
| Oxide, Micronox H, | | | | | | | | |
| Promindsa, | | | | | | | | |
| Wollastonite | | | | | | | | |
| Casiflux F75 | | | | | | | | |
| (ANkerport NV- | | | | | | | | |
| Netherlands), | | | | | | | | |
| Nepheline syenite | | | | | | | | |
| Silicato MN/SA 15, | | | | | | | | |
| Minerals I derivats) | | | | | | | | |
| Solid particles with | 10 | 10 | | | | | | |
| Rosin entrapped in | | | | | | | | |
| silica aerogel | | | | | | | | |
| (Example 2) | | | | | | | | |
| Solid particles with | | | | 7 | | 7 | | 7 |
| Rosin-modified | | | | | | | | |
| polymer entrapped | | | | | | | | |
| in silica aerogel | | | | | | | | |
| (Example 3) | | | | | | | | |
| Zinc Oxide, Zinc | | | | | 2 | 2 | 5 | 5 |
| Oxide | | | | | | | | |
| KS-1, SB Chemical | | | | | | | | |
| CO, LTD | | | | | | | | |
| Copper (I) oxide, | 18 | 18 | 28 | 21 | 28 | 21 | | |
| NA-Cuprous Oxide | | | | | | | | |
| Red, Spiess | | | | | | | | |
| Cuprous Oxide, low | | | | | | | 21 | 14 |
| tint Lo Lo Tint 97, | | | | | | | | |
| American Chemet | | | | | | | | |
| Corp | | | | | | | | |
| Copper pyrithione | 5 | 5 | 5 | 5 | | | 6 | 6 |
| Copper Omadine, | | | | | | | | |
| ARCH Chemiclas | | | | | | | | |
| Total | 100 | 100 | 100 | 100 | 100 | 100 | 101 | 101 |
| Total Pigment | 38 | 38 | 38 | 38 | 35 | 35 | 44 | 44 |
| phase | | | | | | | | |
| Leached layer | 13 | 16 | 22 | 19 | 20 | 20 | 32 | 38 |
| thickness at steady | | | | | | | | |
| state (μm) | | | | | | | | |
| Polishing rate | 3 | 5 | 1 | 2 | 2 | 1 | 19 | 11 |
| (μm/10,000 NM) | | | | | | | | |
| after 19,980 NM | | | | | | | | |

### Discussion:

The results show that it is possible to substitute at least a portion of the soluble pigments with particles of entrapped/encapsulated rosin in commercial-type paint compositions.

### Example 5

### Stability of Solid Particles in Artificial Seawater

| | Hydrogenated | Rosin polymer |
|---|---|---|
| | rosin (reference) | entrapped (Example 3) |
| Amount of rosin extracted by | 1.0 ± 0.4 | 1.2 ± 0.2 |
| artificial seawater relative to | | |
| measurements on pure rosin | | |

### Example 6

### Stability of Solid Particles Immersed in Toluene

| | | Rosin polymer |
|---|---|---|
| | Hydrogenated | entrapped in an silica |
| | rosin | aerogel matrix |
| | (free form) | (Example 3) |
| Final weight of the | 0* | 70^{#} |
| particle in wt % of | | |
| initial weight | | |
| Time before weight | N/A* | <6 days |
| becomes stable | | |

*The particle completely dissolves.
^{#}The silica aerogel matrix is completely insoluble in xylene.

1-12. (canceled)

13. A self-polishing antifouling paint composition comprising:
30-80% by solids volume of the paint composition of a binder phase;
20-70% by solids volume of the paint composition of a pigment phase, said pigment phase including solid particles consisting of one or more rosin constituents entrapped or encapsulated in a matrix; and
optionally one or more solvents.

14. The paint composition according to claim 13, wherein the one or more rosin constituents are selected from rosin, rosin derivatives and rosin-modified polymers.

15. The paint composition according to claim 13, wherein said solid particles have a weight average diameter of 0.10-50 μm.

16. The paint composition according to claim 13, wherein said solid particles are insoluble in xylene to such an extent that at least 60% of the weight of a sample of the solid particles is maintained after testing in the Xylene solubility test described herein.

17. The paint composition according to claim 13, wherein the one or more rosin constituents are entrapped in the pores of the matrix.

18. The paint composition according to claim 13, wherein the one or more rosin constituents are entrapped in the pores of a silica gel.

19. The paint composition according to claim 13, wherein the one or more rosin constituents are entrapped in the pores of an aerogel.

20. The paint composition according to claim 13, wherein the one or more rosin constituents are encapsulated within a shell of the matrix.

21. The paint composition according to claim 20, wherein the shell of the matrix within which the one or more rosin constituents are encapsulated is water-permeable, water degradable or water-erodible.

22. The paint composition according to claim 14, wherein the one or more rosin constituents are encapsulated within a shell of the matrix.

23. The paint composition according to claim 22, wherein the shell of the matrix within which the one or more rosin constituents are encapsulated is water-permeable, water degradable or water-erodible.

24. The paint composition according to claim 14, wherein the one or more rosin constituents are selected from rosin-modified polymers.

25. The paint composition according to claim 24, wherein the rosin-modified polymers have a weight average molecular weight of at least 1,500 g/mol.

26. A method for the preparation of the self-polishing antifouling paint composition as defined in claim 13, said method comprising the step of bringing solid particles consisting of one or more rosin constituents entrapped or encapsulated in a matrix in admixture with a binder system and one or more constituents selected from dyes, additives, solvents, pigments, fillers, fibres and anti-fouling agents, and any other suitable constituents to be included in either the binder phase or the pigment phase of paint compositions.

27. A method for providing a self-polishing effect of a paint composition, the method comprising the step of incorporating into the paint composition solid particles consisting of one or more rosin constituents entrapped or encapsulated in a matrix.

28. A marine structure coated with one or several layers, in particular successive layers, of a paint composition as defined in claim 13.
